(19) United States
(12) Patent Application Publication
(10) Pub. No.: US 2005/0000538 A1
(43) Pub. Date: Jan. 6, 2005

(54) Combination key holder and sanitary dental floss dispenser

(76) Inventors: Deborah L. Blasi, Terryville, CT (US); Catherine L. Pelletier, Terryville, CT (US)

Correspondence Address: WILLIAM C. CRUTCHER;MCCORMICK, PAULDING & HUBER, LLP, 185 ASYLUM STREET, CITY PLACE II, 18TH FLOOR, HARTFORD, CT, 06103-4102, US

(21) Appl. No.: 10/613,137

(22) Filed: Jul. 3, 2003

(51) Int. Cl. A61C 15/00

(52) U.S. Cl. 132/325

(57) ABSTRACT

A combination dental floss dispenser and key chain, with sanitary cover for floss and replaceable spool of floss. The dispenser is of a single plastic molding.

### BACKGROUND OF THE INVENTION

Dental floss dispensers are well known in the art, of the type wherein a spool of dispensable dental floss is held within a closable compartment and floss is fed through an opening to a location outside the dispenser, where a floss cutter is located. A selected length of floss is removed from the spool by pulling the floss against the floss cutter blade, commonly made of metal. In many cases, the cutter and exposed floss are protected by a cover piece.

Exemplary of such dispensers is U.S. Pat. No. 6,302,121 issued Oct. 16, 2001 to McConnell, this patent being only representative of many different variations of dental floss dispensers.

It has been suggested in the prior art also that dental floss dispensers be combined with other devices. Exemplary of these patents are a combined floss dispenser and comb shown in U.S. Pat. Des. No. 247,395 issued Feb. 28, 1978 to Earl; a combination floss dispenser and stand-up toothpaste container described in U.S. Pat. No. 5,979,706 issued Nov. 9, 1999 to Grussmark; a bottle cap with dental floss dispenser described in U.S. Pat. No. 5,180,090 issued Jan. 19, 1993 to Douglas; and a combination writing utensil and floss dispenser described in U.S. Pat. No. 6,024,104 issued Feb. 15, 2002 to Dolberry. Such combinations have various degrees of usefulness, but sometimes lack the ability to always be carried on the person in a pocket or purse so as to be handy at all times.

A combination key holder and floss dispenser is illustrated in U.S. Pat. Des. No. 329,137 issued Sep. 8, 1992 to Hinson. This is a disk shaped dispenser with a rectangular window through the center and a section adapted to receive a key ring. The internal construction is not shown. A floss port for dispensing a length of floss and a projecting cutter blade extend outside the disk.

A key holder, which is carried in a pocket or purse, is exposed to all of the other objects carried in the pocket or purse, as well as extraneous dirt or potentially contaminating material. There exists the need for a sanitary floss dispenser that does not expose the floss and floss cutter to contamination, and which is also constructed to function as a portable and useful key holder.

Accordingly, one object of the present invention is to provide an improved combination key holder and sanitary dental floss dispenser.

Another object of the invention is to provide an improved construction for a combination key holder and sanitary floss holder, in which the spool of floss is replaceable.

Still another object of the invention is to provide an improved construction for an injection molded single piece key holder and floss dispenser.

### SUMMARY OF THE INVENTION

Briefly stated, the invention comprises a combination key holder and sanitary dental floss dispenser with a case defining a first closable compartment, the case having a floss dispensing wall portion with an opening therein, a spool of dispensable floss disposed in the first closable compartment to feed floss through the opening, a floss cutter disposed in said floss dispensing wall portion, a cover so dimensioned as to fit over the floss dispensing wall portion to define a second closable compartment, an attachment portion integral with a part of the case and extending beyond the case outside the first and second compartments, and a key holder connected to the attachment portion and adapted to receive at least one key.

In its preferred form, the case, cover, and attachment portion are made as a single plastic injection molding with a living hinge connecting mating case halves and a living hinge connecting the cover to the case.

### DRAWING

The invention will be better understood by reference to the following description, taken in connection with the accompanying drawing, in which:

FIG. 1 is a perspective view of the combined key holder and sanitary dental floss dispenser,

FIG. 2 is a plan view of the key holder dispenser of FIG. 1,

FIG. 3 is a left side elevational view of the dispenser of FIG. 1,

FIG. 4 is a left side elevational view of the key holder dispenser in a fully opened condition to show internal construction,

FIG. 5 is a top plan view of the key holder dispenser seen in FIG. 4,

FIG. 6 is an end elevational view of the key holder dispenser shown in FIG. 4,

FIG. 7 is a left side elevational view of the key holder dispenser with case closed but cover opened for dispensing of floss,

FIG. 8 is a top plan view of the key holder dispenser as shown in FIG. 7, and

FIG. 9 is an end elevational view of the key holder dispenser as shown in FIG. 7.

### DESCRIPTION OF THE PREFERRED EMBODIMENT

Referring now to FIG. 1 of the drawing, the combination key holder and sanitary dental floss dispenser is shown generally at 10 to comprise a case 12 with a cover 14 on one end and an attachment portion 16 on the other end. The attachment portion is provided with a hole 18 for receiving an intermediate connector 20. A split ring 22 is linked with connector 20 and a key 24 by separating a section of ring 22 and rotating it to thread it over the connector and through the hole in key 24 in a manner well known in the art. The remainder of the drawings eliminate key 24 for purposes of clarity, since any number of keys or various types of key rings or key chains may be attached to the intermediate connector 20, the types of key rings or key chains not being material to the present invention.

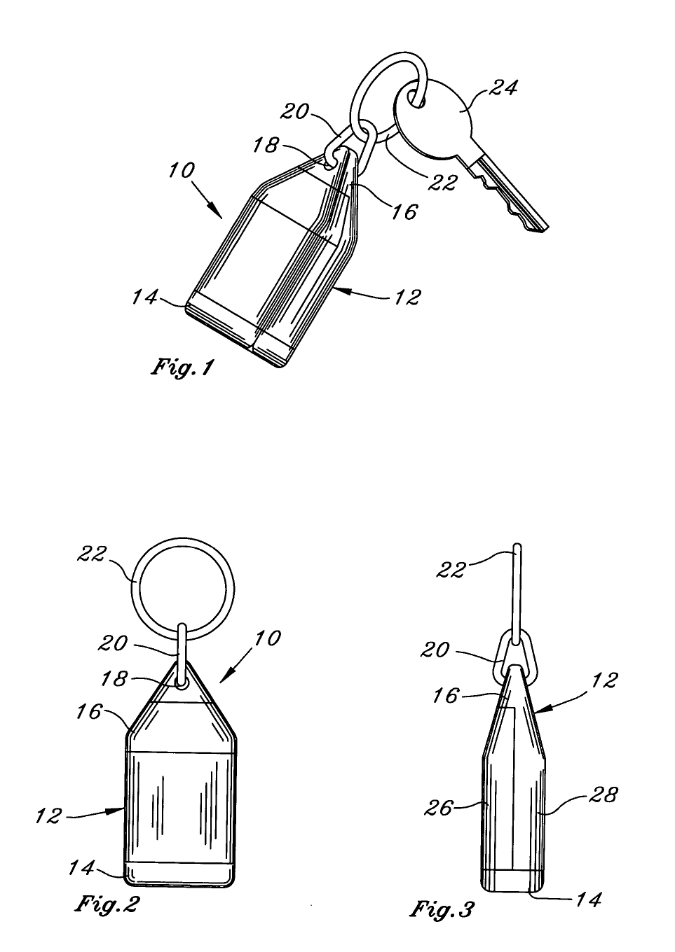

Referring to FIGS. 2 and 3 of the drawing, the case 12 is seen to be generally rectangular on the end to which cover 14 is attached and tapering on the other end to join the attachment portion 16. As seen in FIG. 3, case 12 is preferably fabricated in a bottom half 26 and a top half 28, with the attachment portion 16 formed as an integral part of top half 28. The attachment portion 16 could equally well be an integral part of the bottom half 26, this being merely a matter of choice, both the bottom half 26 and top half 28 are folded together to form the case.

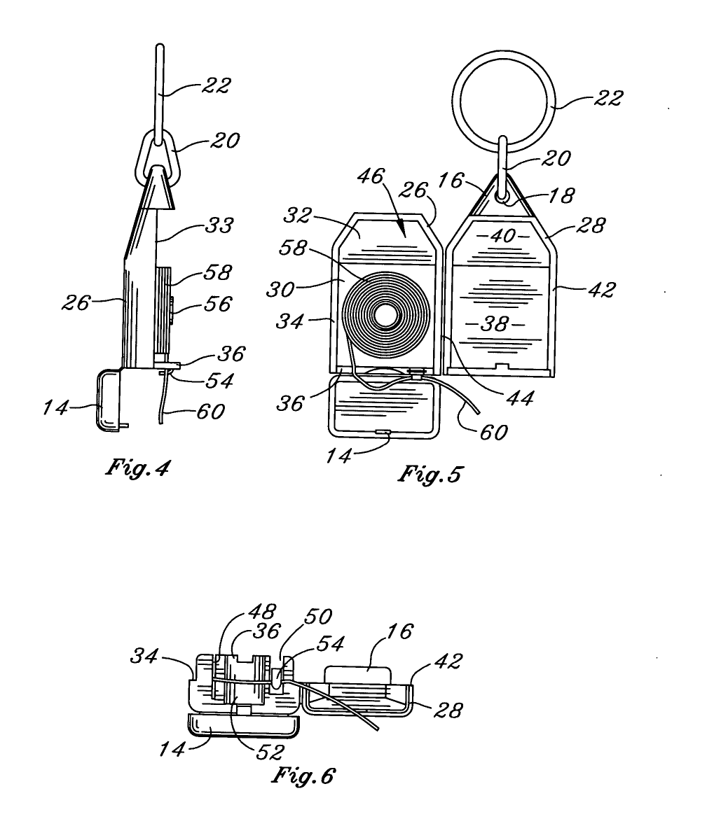

Referring now to FIGS. 4, 5 and 6 of the drawing, the views illustrate the internal construction of the key holder dispenser. The bottom half 26 comprises a bottom consisting of a flat panel 30 connected to a tapered panel 32, these panels being partially surrounded by a bottom wall 34 extending around three sides of the panels 30, 32. A taller dispensing wall portion 36 extends between the ends of bottom wall 34 to surround the bottom panels 30, 32. The case top 28 is similarly constructed with a top consisting of a flat panel 38 connected to a tapered panel 40. A top wall 42 extends around three sides of the top. The attachment portion 16 extends beyond the top wall 42, and is a solid piece provide with a hole 18.

In the preferred embodiment, the bottom and top walls 34 and 32 of the bottom 26 and top 28 respectively have a straight section connected by a living hinge 44 so that top and bottom can be molded as a single injection molding. The bottom wall 34, dispensing wall portion 36 and top wall 42 are so dimensioned and arranged so that they mate precisely with one another to provide a first closable compartment 46 when the top and bottom halves are folded together.

Reference to FIG. 6 shows that the floss dispensing wall portion 36 defines a first slit 48 and a second slit 50. Slits 48 and 50 are spaced from one another by a bridging wall portion 52. A metal floss cutter 54 is disposed in the second slit 50.

In order to hold a spool of dispensable floss, a cylindrical projection 56 molded as part of the bottom panel 30 projects from the bottom panel. A spool of dispensable floss 58 is disposed on the projection 56, so that a length of floss 60 may be brought through slit 48 and fed through cutter 54. The key holder dispenser may be fully opened as shown in FIGS. 4, 5 and 6 to replace the spool 56 of floss.

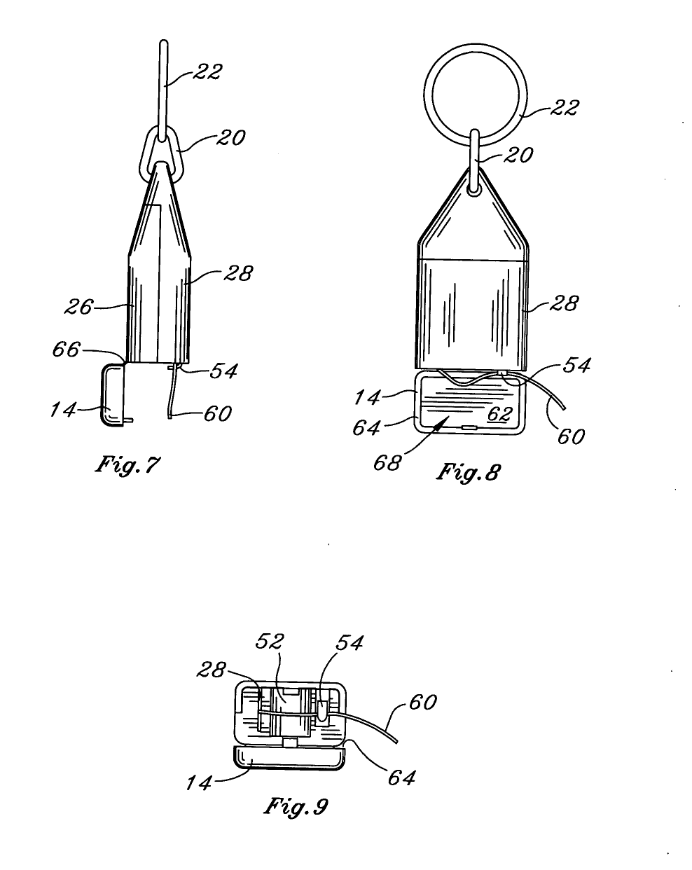

Referring now to FIGS. 7, 8 and 9, the key holder dispenser is shown in partially opened condition with the cover 14 open for dispensing a length of floss 60. As indicated in the drawing, the cover 14 comprises a rectangular bottom panel 62 with a peripheral wall 64. Preferably cover 14 is part of the same plastic injection molding and is connected to the case by a living hinge 66. The bottom 14 is so dimensioned as to fit over the floss dispensing wall portion to define a second closable compartment 68. When so closed, the cutter 54 and the floss exposed along the bridging wall 52 are inside the second closable compartment, so that they may be protected in a sanitary manner from dirt or contamination in a pocket or purse. In this way, the dispenser case 12 fully protects the floss, while the case 12 may be used as a tab to locate and use key 24.

The preferred embodiment utilized a plastic injection molding. However, it is within the scope of the invention to make the case halves and cover out of separate metal parts and to connect them with hinges. Precious metals such as silver or gold may be used to create unique combined key holders and sanitary floss dispensers, in which the floss spool may be replaced.

While there has been described what is considered to be the preferred embodiment of the invention, other modifications will occur to those skilled in the art. It is desired to secure all such modifications as fall within the true spirit and scope of the invention.

1. A combination key holder and sanitary dental floss dispenser, comprising, a case defining a first closable compartment, said case having a floss dispensing wall portion with an opening therein,
a spool of dispensable floss disposed in said first closable compartment to feed floss through said opening,
a floss cutter disposed in said floss dispensing wall portion,
a cover so dimensioned as to fit over said floss dispensing wall portion to define a second closable compartment,
an attachment portion integral with said case and extending beyond the case outside the first and second compartments, and
a key holder connected to said attachment portion and adapted to receive at least one key.

2. The combination according to claim 1, wherein said case comprises a case top and a case bottom and first hinge means connecting the case top to the case bottom so that the case top may be folded toward the case bottom to form said first closable compartment.

3. The combination according to claim 1, wherein said attachment portion is integral with said case top.

4. The combination according to claim 1, wherein said attachment portion is integral with said case bottom.

5. The combination according to claim 1, including second hinge means connecting the case with the cover so that the cover may be folded over the floss dispensing wall portion to provide said second closable compartment.

6. A combination key holder and sanitary dental floss dispenser, comprising,
a case bottom having a bottom panel and a bottom wall extending around said bottom panel, said bottom wall including a floss dispensing wall portion defining first and second spaced slits therein,
a case top having a top panel and a top wall extending around said top panel,
first hinge means connecting said top wall to said bottom wall so that the case top may be folded toward the case bottom, said top and bottom walls being so disposed and dimensioned to provide a case defining a first closable compartment,
a spool of dispensable floss disposed in said first closable compartment so that the floss may be withdrawn through said first slit,
a floss cutter disposed in said second slit,
a cover member so dimensioned as to fit over said floss dispensing wall portion,
second hinge means connecting the case with the cover member so that the cover member may be folded over the floss dispensing wall portion to define a second closable compartment,
an attachment portion integral with said case and extending beyond the case outside the first and second compartments, and
a key holder connected to said attachment portion and adapted to receive at least one key.

7. The combination according to claim 6, wherein said case is a single plastic injection molding and wherein said top wall and said top wall have adjacent wall portions connected by a first living hinge.

8. The combination according to claim 6, wherein said case comprises a case top and a case bottom and first hinge means connecting the case top to the case bottom so that the case top may be folded toward the case bottom to form said first closable compartment.

9. The combination according to claim 6, wherein said attachment portion is integral with said case top.

10. The combination according to claim 6, wherein said attachment portion is integral with said case bottom.

11. The combination according to claim 6, wherein said case, said attachment portion and said cover are a single plastic injection molding and wherein said case and said cover have adjacent wall portions connected by a second living hinge.
